(19) United States
(12) Patent Application Publication
(10) Pub. No.: US 2023/0403986 A1
(43) Pub. Date: Dec. 21, 2023

(54) HORTICULTURE MASTER AND SLAVE LIGHTING DEVICES

(71) Applicant: SIGNIFY HOLDING B.V., EINDHOVEN (NL)

(72) Inventors: Bartel Marinus VAN DE SLUIS, EINDHOVEN (NL); Marcellinus Petrus Carolus Michael KRIJN, EINDHOVEN (NL); Rob Franciscus Maria VAN ELMPT, ROERMOND (NL)

(21) Appl. No.: 17/913,740

(22) PCT Filed: Mar. 23, 2021
(86) PCT No.: PCT/EP2021/057447

§ 371 Date: Sep. 22, 2022

(30) Foreign Application Priority Data
Mar. 26, 2020 (EP) 20165775.6

(51) Int. Cl. A01G 7/04

(52) U.S. Cl. CPC A01G 7/045

(57) ABSTRACT

The invention concerns a horticulture master lighting device (11) comprises a light source and a processor configured to determine one or more horticulture master light settings and control the light source to render horticulture master light based on the one or more horticulture master light settings. The horticulture master light illuminates a plant (3) from a first position and further comprises a modulated light communication signal. The invention further concerns a horticulture slave lighting device (21) comprises a light sensor, a light source, and a processor configured to receive, via the light sensor, the horticulture master light from the horticulture master lighting device, determine one or more horticulture slave light settings based on the modulated light communication signal, and control the light source to render horticulture slave light based on the one or more horticulture slave light settings. The horticulture slave light illuminates the plant from a second position.

### FIELD OF THE INVENTION

The invention relates to horticulture lighting devices for illuminating a plant in a plant growing environment.

The invention further relates to methods of illuminating a plant in a plant growing environment.

The invention also relates to computer program products enabling a computer system to perform a method of illuminating a plant in a plant growing environment.

### BACKGROUND OF THE INVENTION

Growing of crops in greenhouses has been common practice for a long time.

For the photosynthesis of the plants, the sun is being used as a main source of light. In recent years, the dark periods of the day have been filled in with artificial lighting to boost the growth of the crops. First, HID lamps were used. The HID lamps are in the process of being replaced by LED. Advantages of LED are the capability to spectrally tune the LEDs according to the plants' and humans' needs or desires, the higher efficacy of LED as compared to HID, and the fact that they can be instantaneously dimmed or boosted.

One of the issues in horticulture lighting is that when plants reach a certain size, their leaves prevent light from above to reach the lower parts of the plant. In order to illuminate the lower parts of the plant, inter-lighting devices and/or bottom-lighting devices can be used to illuminate the plants from a different angle. For example, JP2015092861A discloses an arrangement wherein the plant is surrounded by LEDs arranged at the top, LEDs arranged at the sides and LEDs arranged near the bottom. Each attachment angle is configured to be adjustable so that light can be irradiated to the crop at an arbitrary angle.

A drawback of the use of inter-lighting devices and/or bottom-lighting devices is that the light settings of these horticulture lighting devices need to be configured seperately, requiring the plant grower to perform extra work.

### SUMMARY OF THE INVENTION

It is a first object of the invention to provide horticulture lighting devices, which enable use of inter-lighting devices and/or bottom-lighting devices without requiring separate configuration of light settings.

It is a second object of the invention to provide methods, which enable use of inter-lighting devices and/or bottom-lighting devices without requiring separate configuration of light settings.

In a first aspect of the invention, a horticulture slave lighting device for illuminating a plant in a plant growing environment comprises a light sensor for receiving horticulture master light from a horticulture master lighting device, said horticulture master light comprising a modulated light communication signal and said horticulture master light illuminating said plant from a first position, a light source, and at least one processor configured to receive, via said light sensor, said modulated light communication signal, determine one or more horticulture slave light settings based on said modulated light communication signal, and control said light source to render horticulture slave light based on said one or more horticulture slave light settings, said horticulture slave light illuminating said plant from a second position. Said modulated light communication signal may be a visible light communication signal or an infrared light communication signal, for example.

Said horticulture slave light may be different from said horticulture master light, i.e. at least one light characteristic of said horticulture slave light and said horticulture master light may be different, wherein the at least one light characteristic may be a spectral light distribution and/or a light intensity. Characteristics of the horticulture master light may be determined from the horticulture master light itself as received by the sensor or from horticulture master light settings included in the modulated light communication signal received by the sensor.

For instance, the horticulture slave lighting device may be an inter-lighting device which generates grow light output in accordance with grow light properties detected from the top-lighting device. The inter-lighting device may be a portable lighting device temporarily positioned between the plants in order to illuminate the lower parts of the plant, for example.

By determining one or more horticulture light settings for a first horticulture lighting device, which illuminates a certain plant, based on a modulated light communication signal transmitted by a second horticulture lighting device, which illuminates the same plant from a different position, no separate configuration of light settings is required for the first horticulture lighting device. For example, the light settings may be transmitted using modulated light communication in the manner disclosed in US 2016/0338173 A1. The modulated light communication signal transmitted by the second horticulture lighting device can be used to determine the light settings for the first horticulture lighting device despite the fact that the horticulture lighting devices illuminate the same plant from a different position.

Said horticulture master light illuminates said plant from a first angle and said horticulture slave light illuminates said plant from a second angle. These angles are from the perspective of the plant or a part thereof (e.g. a central/gravity point of the plant). Therefore, as the plant or plant part is considered the reference point, a position of the light source (whether master or slave) relative to the plant or plant part also determines the angle of illumination of the plant or plant part. Light sources which illuminate the plant from two different positions illuminate the plant under different angles. The difference between the first illumination angle and the second illumination angle typically exceeds 30 degrees and may be larger than 90 degrees, e.g. if the horticulture master lighting device is a top-lighting device and the horticulture slave lighting device is a bottom-lighting device.

Said horticulture slave lighting device may be one of: a top-lighting device, an inter-lighting device and a bottom-lighting device, for example. Said horticulture slave lighting device may be adapted to move together with said plant in said plant growing environment. For instance, plants may move through zones with different light and/or climate conditions. This makes it possible to use light conditions that depend on the growth stage of a plant without requiring the light settings of the stationary top-lighting devices to be regularly adjusted. However, in certain situations, it is beneficial to have the horticulture slave lighting device move together with the plant, e.g. when the horticulture slave lighting device is embedded in a plant tray, plant gully, or plant pot or attached to a plant, plant tray, plant gully, or plant pot in order to provide optimal lighting.

Said received modulated light communication signal may comprise one or more of: said one or more horticulture slave light settings, one or more horticulture master light settings, a horticulture light protocol identifier, and an identifier of said horticulture master lighting device.

Said received modulated light communication signal may comprise said one or more horticulture slave light settings, for example. This allows the horticulture slave lighting device to be relatively simple, but this requires the horticulture master lighting device to determine the horticulture slave light settings, which may increase the complexity of the horticulture master lighting device.

Said received modulated light communication signal may comprise said one or more horticulture master light settings, for example. In that case, said at least one processor may be configured to determine said one or more horticulture slave light settings based on said one or more horticulture master light settings by adjusting said one or more horticulture master light settings. Since the horticulture master and slave lighting devices illuminate different portions of the plant, it may be beneficial to use horticulture slave settings that are different than the horticulture master light settings. For example, in the case of growing medicinal cannabis plants during their flowering stage, the horticulture master light setting(s) above the plant may be optimized for medicinal content production of the flowers (implying high light intensity levels and stressing the plant). At the same time, the horticutlure slave light setting(s) may be optimized for photosynthesis in the lower part of the plants. In the case of growing high-wire tomato plants, the horticulture master light setting(s) above the plant may be optimized for photosynthesis, while the horticulture slave light setting(s) may (partially) illuminate the tomatoes and be optimized for vitamin C production in the tomatoes.

Said received modulated light communication signal may comprise said light protocol identifier and/or said identifier of said horticulture master lighting device, for example. Said horticulture slave lighting device may further comprise a transmitter and a receiver and said at least one processor may be configured to transmit, via said transmitter, said light protocol identifier and/or said identifier of said horticulture master lighting device to a server system, and receive, via said receiver, said one or more horticulture slave light settings and/or one or more horticulture master light settings from said server system in response to said transmission. Said identifier of said horticulture master lighting device may identify a location of said horticulture master lighting device, for example.

This may make the horticulture slave lighting device a bit more complex, because it needs to comprise a transmitter and a receiver, but this allows the horticulture slave lighting device to retrieve detailed information about the applicable (e.g. growth) light protocol and/or retrieve horticulture slave light settings optimized for the specifics of the horticulture slave lighting device. To achieve the latter, said at least one processor may be configured to transmit information describing hardware characteristics of said horticulture slave lighting device to said server system along with said light protocol identifier and/or said identifier of said horticulture master lighting device, and receive said one or more horticulture slave light settings from said server system in response to said transmission, said one or more horticulture slave light settings being determined based on said hardware characteristics of said horticulture slave lighting device.

Said one or more horticulture master light settings and/or said one or more horticulture slave light settings may comprise a spectral light distribution setting and/or a light intensity level, for example.

Compared to the light intensity level above the plant, the light intensity level at the location of the horticulture slave lighting device, e.g. between the plants or close to the bottom of the plants, may be attenuated due to light interception by the plant's canopy. The degree of attenuation is an indication of the plant status or the plant's growth stage. For example, in case of a mature healthy vigorous plant with a dense foliage, there will be a large attenuation of the daylight and master light while travelling downwards into the plant. In case of a young and not yet well-developed plant, the attenuation will be much less. In embodiments the horticulture slave lighting device may be equiped with an additional light sensor to measures the light intensity level (e.g. the photon flux density, or the photosynthetic photon flux density, or the spectrum as a whole) at the location of the horticulture slave ligthing device. The additional light sensor may be integrated/combined with the light sensor for measuring the horticulture master light setting(s) and the modulated light communication signal. The desired horticulture slave light settings, in terms of spectrum and/or intensity level, may be determined from a horticulture light protocol. In this case, the horticulture master lighting device receives from a server system the desired horticulture master light setting(s) as well as a desired horticulture slave light setting(s). The horticulture master lighting device communicates the desired horticulture slave light setting(s) to the horticulture slave lighting device, using the modulated light communication signal. Then, the horticulture slave lighting device uses the light sensor to measure the actual horticulture light setting(s), in terms of spectrum and/or intensity level, at the location of the horticulutre slave lighting device and compares this with the received desired horticulture slave light setting(s). In case the desired horticulture slave light setting(s) deviate from the actual horticulture light setting(s), the missing spectrum or light intensity is augmented by the horticulture slave lighting device to, as close as possible, result in the desired horticulture slave light setting(s). Alternativly, the desired horticulture slave light settings, in terms of spectrum and/or intensity level, may be determined by the service system. In this case, the additional sensor at the horticulture slave lighting device measures the actual horticulture light setting(s) at the location of the horticulture slave lighting device and communicates this to the server system (preferably wirelessly). This information is processed by the server system to determine a desired horticulture slave light setting(s). This desired horticulture slave light setting(s) is communicated back to the horticulture slave lighting device (preferably wirelessly). In a further alternative, but slightly more complex, the additional sensor at the horticulture slave lighting device measures the actual horticulture light setting(s) at the location of the horticulture slave lighting device and communicates this to the horticulture master lighting device through another modulated light communication signal. In this case, the horticulture master lighting device and the horticulture slave lighting device both have a light sensor for detecting horticulture light and modulated light communication signals comprised therein and both devices can communicate bidirectionally with each other via such modulated light communication signals. The information on the actual horticulture light setting(s) at the location of the horticulture slave lighting device is processed by the horticulture lighting device to determine a desired horticulture slave light setting(s), which is communicated back to the horticulture slave lighting device via modulated light communication signals in the horticulture master light.

Further reasons why the horticulture slave light (settings) may be different from the horticulture master light (setings) include the position of the lighting devices relative to the plant (e.g. top lighting, inter-lighting, bottom-lighting) and therewith the plant part being illuminated (e.g. leaves versus fruits), the type of lighting devices (e.g. LED, SON-T, etc.), the capabilites of lighting devices in terms of their specifications such as light spectrum and/or available spectral tunability and/or light intensity levels, etc., and the functionality of the lighting devices (e.g. photosynthetic light, flowering light, fruit ripening light, plant nutritional value improving light, etc.). Nonetheless, although the horticulture slave light (settings) may be different from the horticulture master light (settings) they still are related via the plant's position, the plant's needs (in terms of illumination) and/or the plant's growth stage.

In a second aspect of the invention, a horticulture master lighting device for illuminating a plant in a plant growing environment comprises a light source and at least one processor configured to determine one or more horticulture master light settings and control said light source to render horticulture master light based on said one or more horticulture master light settings, said horticulture master light further comprising a modulated light communication signal, said modulated light communication signal comprising at least one of: said one or more horticulture master light settings, one or more horticulture slave light settings, and a horticulture light protocol identifier.

In a third aspect of the invention, a horticulture lighting system for illuminating a plant in a plant growing environment comprises said horticulture slave lighting and said horticulture master lighting device. Said horticulture master lighting device may be stationary within said plant growing environment and said horticulture slave lighting device may be adapted to move with said plant in said plant growing environment, for example.

In a fourth aspect of the invention, a method of illuminating a plant in a plant growing environment with horticulture slave light comprises receiving, via a light sensor, horticulture master light from a horticulture master lighting device, said horticulture master light comprising a modulated light communication signal and said horticulture master light illuminating said plant from a first position, determining one or more horticulture slave light settings based on said modulated light communication signal, and rendering said horticulture slave light based on said one or more horticulture slave light settings, said horticulture slave light illuminating said plant from a second position. Said method may be performed by software running on a programmable device. This software may be provided as a computer program product.

In a fifth aspect of the invention, a computer program or suite of computer programs comprises at least one software code portion or a computer program product storing at least one software code portion, the software code portion, when run on a processor of said horticulture slave lighting device, being configured for performing said method of illuminating a plant in a plant growing environment with horticulture slave light.

In a sixth aspect of the invention, a method of illuminating a plant in a plant growing environment with horticulture master light comprises determining one or more horticulture master light settings and rendering said horticulture master light based on said one or more horticulture master light settings, said horticulture master light further comprising a modulated light communication signal, said modulated light communication signal comprising at least one of: said one or more horticulture master light settings, one or more horticulture slave light settings, and a horticulture light protocol identifier. Said method may be performed by software running on a programmable device. This software may be provided as a computer program product.

In a seventh aspect of the invention, a computer program or suite of computer programs comprises at least one software code portion or a computer program product storing at least one software code portion, the software code portion, when run on a processor of said horticulture master lighting device being configured for performing said method of illuminating a plant in a plant growing environment with horticulture master light.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

A non-transitory computer-readable storage medium stores at least a first software code portion, the first software code portion, when executed or processed by a computer, being configured to perform executable operations comprising receiving, via a light sensor, a modulated light communication signal, wherein said modulated light communication signal is comprised in horticulture master light from a horticulture master lighting device, said horticulture master light received by said light sensor and illuminating a plant from a first position, determining one or more horticulture slave light settings based on said modulated light communication signal, and rendering horticulture slave light based on said one or more horticulture slave light settings, said horticulture slave light illuminating said plant from a second position.

A non-transitory computer-readable storage medium stores at least a second software code portion, the second software code portion, when executed or processed by a computer, being configured to perform executable operations comprising determining one or more horticulture master light settings and rendering horticulture master light based on said one or more horticulture master light settings, said horticulture master light further comprising a modulated light communication signal, said modulated light communication signal comprising at least one of: said one or more horticulture master light settings, one or more horticulture slave light settings, and a horticulture light protocol identifier.

As will be appreciated by one skilled in the art, aspects of the present invention may be embodied as a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a block diagram of a first embodiment of the horticulture lighting system;

FIG. 2 is a block diagram of the horticulture master and slave lighting devices of FIG. 1;

FIG. 3 is a block diagram of horticulture master and slave lighting devices in a second embodiment of the horticulture lighting system;

FIG. 4 is a block diagram of a third embodiment of the horticulture lighting system;

FIG. 5 is a block diagram of the horticulture master and slave lighting devices of FIG. 4;

FIG. 6 is a block diagram of horticulture master and slave lighting devices in a fourth embodiment of the horticulture lighting system;

FIG. 7 is a block diagram of a fifth embodiment of the horticulture lighting system;

FIG. 8 is a block diagram of the horticulture master and slave lighting devices of FIG. 7;

FIG. 9 is a block diagram of horticulture master and slave lighting devices in a sixth embodiment of the horticulture lighting system;

FIG. 10 is a block diagram of a seventh embodiment of the horticulture lighting system;

FIG. 11 is a block diagram of the horticulture master and slave lighting devices of FIG. 10;

FIG. 12 is a block diagram of horticulture master and slave lighting devices in an eighth embodiment of the horticulture lighting system;

FIG. 13 is a flow diagram of a first embodiment of the methods;

FIG. 14 is a flow diagram of a second embodiment of the methods;

FIG. 15 is a flow diagram of a third embodiment of the methods; and

FIG. 16 is a block diagram of an exemplary data processing system for performing the method of the invention.

Corresponding elements in the drawings are denoted by the same reference numeral.

### DETAILED DESCRIPTION OF THE EMBODIMENTS

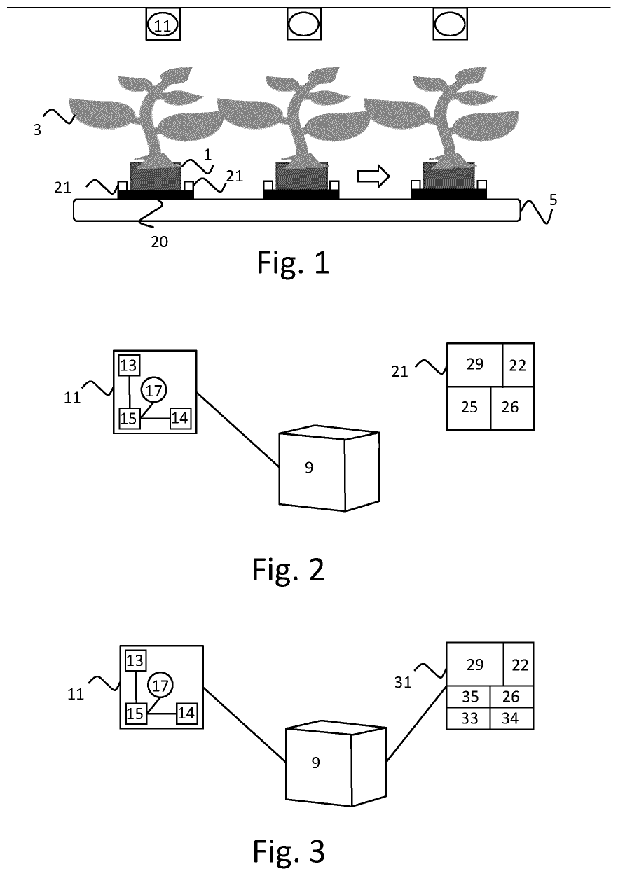

FIG. 1 shows a first embodiment of the horticulture lighting system in a plant growing environment. In the embodiment of FIG. 1, the horticulture lighting system comprises a horticulture top-lighting device 11 and two horticulture bottom-lighting devices 21. The horticulture top-lighting device 11 illuminates a plant 3 from a first position. The horticulture bottom-lighting devices 21 illuminate the plant 3 from second positions. In the embodiment of FIG. 1, the two horticulture bottom-lighting devices 21 have been attached to a plant tray 20. The plant tray 20 comprises a plant pot 1, which comprises the plant 3. Alternatively, the horticulture bottom-lighting devices 21 may be embedded in the plant tray 20, may be attached to the plant 3, or may be embedded in or attached to the plant pot 1.

In the example of FIG. 1, the horticulture bottom-lighting devices 21 are adapted to move together with the plant 3 in the plant growing environment. Multiple plant trays, including plant tray 20, are moving on a conveyor belt 5. In an alternative embodiment, the plant 3 is planted in a plant gully and moving in a mobile gully system and the horticulture bottom-lighting devices 21 have been embedded in or attached to the plant gully. In an alternative embodiment, the plant 3 does not move, but is stationary.

The horticulture top-lighting device 11 and the horticulture bottom-lighting devices 21 are described in more detail in relation to FIG. 2. The horticulture top-lighting device 11 comprises a light source 17, a receiver 13, a transmitter 14, and a processor 15. The processor 15 is configured to determine one or more horticulture master light settings and control the light source 17 to render horticulture master light based on the one or more horticulture master light settings. The horticulture master light further comprises a modulated light communication signal.

In the embodiment of FIG. 2, the processor 15 is configured to determine the one or more horticulture master light settings by transmitting, via transmitter 14, a request message to a server system 9 and receiving, via receiver 13, a response message in return. The response message comprises at least the one or more horticulture master light settings and may comprise the entire light protocol. The horticulture top-lighting device 11 is referred to in this embodiment as a horticulture master lighting device.

The horticulture bottom-lighting devices 21 each comprise a light sensor 22, a processor 25, a power supply 26, and a light source 29. The processor 25 is configured to receive, via the light sensor 22, the modulated light communication signal from the horticulture top-lighting device 11, determine one or more horticulture slave light settings based on the modulated light communication signal, and control the light source 29 to render horticulture slave light based on the one or more horticulture slave light settings. The power-supply 26 may comprise a wireless power receiver and/or a battery, for example. The horticulture bottom-lighting devices 21 are referred to in this embodiment as horticulture slave lighting devices.

The one or more horticulture master light settings and/or the one or more horticulture slave light settings preferably comprise a spectral light distribution setting and/or a light intensity level. In the embodiment of FIG. 2, the modulated light communication signal comprises the one or more horticulture slave light settings and/or the one or more horticulture master light settings. The processor 25 may be configured to determine the one or more horticulture slave light settings based on one or more received horticulture master light settings by adjusting the one or more received horticulture master light settings.

FIG. 3 shows a second embodiment of the horticulture lighting system in the plant growing environment. In this second embodiment, the modulated light communication signal comprises a horticulture light protocol identifier and/or an identifier of the horticulture master lighting device and a horticulture bottom-lighting device 31 comprises an additional receiver 33 and an additional transmitter 34 compared to bottom-lighting device 21 of FIG. 2.

The horticulture bottom-lighting device 31 comprises a processor 35 that differs from the processor 25 of horticulture bottom-lighting device 21 of FIG. 3 in that it transmits, via the transmitter 34, a request message comprising the light protocol identifier and/or the identifier of the horticulture master lighting device to the server system 9 and receives, via the receiver 33, the one or more horticulture slave light settings from the server system 9 in response to the transmission of the request message.

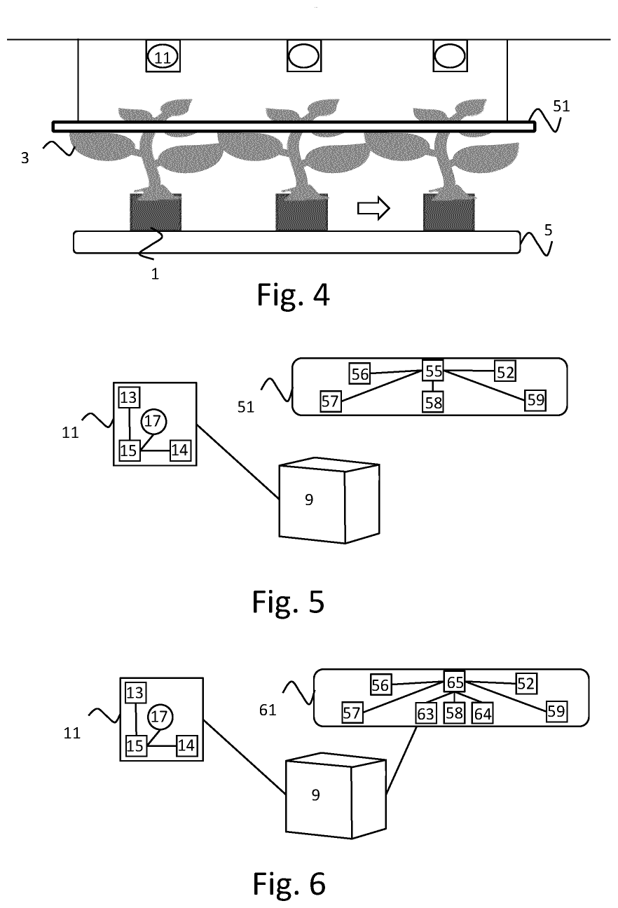

FIG. 4 shows a third embodiment of the horticulture lighting system in the plant growing environment. In the embodiment of FIG. 4, the horticulture lighting system comprises the horticulture top-lighting device 11 of FIG. 2 and a horticulture inter-lighting device 51. The horticulture top-lighting device 11 illuminates the plant 3 from a first position. The horticulture inter-lighting device 51 illuminates the plant 3 from a second position.

The horticulture inter-lighting device 51 is described in more detail in relation to FIG. 5. The horticulture inter-lighting device 51 comprises a light sensor 52, a processor 55, a power supply 56, and three light sources 57-59. The processor 55 is configured to receive, via the light sensor 52, the modulated light communication signal from the horticulture top-lighting device 11, determine one or more horticulture slave light settings based on the modulated light communication signal, and control the light sources 57-59 to render horticulture slave light based on the one or more horticulture slave light settings. The power-supply 56 may comprise a power connector and/or a battery, for example. The horticulture inter-lighting device 51 is referred to in this embodiment as a horticulture slave lighting device.

In the embodiment of FIG. 5, the modulated light communication signal comprises the one or more horticulture slave light settings and/or the one or more horticulture master light settings. The processor 55 may be configured to determine the one or more horticulture slave light settings based on one or more received horticulture master light settings by adjusting the one or more received horticulture master light settings. FIG. 5 also shows the horticulture top-lighting device 11 of FIG. 2.

FIG. 6 shows a fourth embodiment of the horticulture lighting system in the plant growing environment. In this fourth embodiment, the modulated light communication signal comprises a horticulture light protocol identifier and/or an identifier of the horticulture master lighting device and a horticulture inter-lighting device 61 comprises an additional receiver 63 and an additional transmitter 64 compared to inter-lighting device 51 of FIG. 5.

The horticulture inter-lighting device 61 comprises a processor 65 that differs from the processor 55 of horticulture inter-lighting device 51 of FIG. 5 in that it transmits, via the transmitter 64, a request message comprising the light protocol identifier and/or the identifier of the horticulture master lighting device to the server system 9 and receives, via the receiver 63, the one or more horticulture slave light settings from the server system 9 in response to the transmission of the request message.

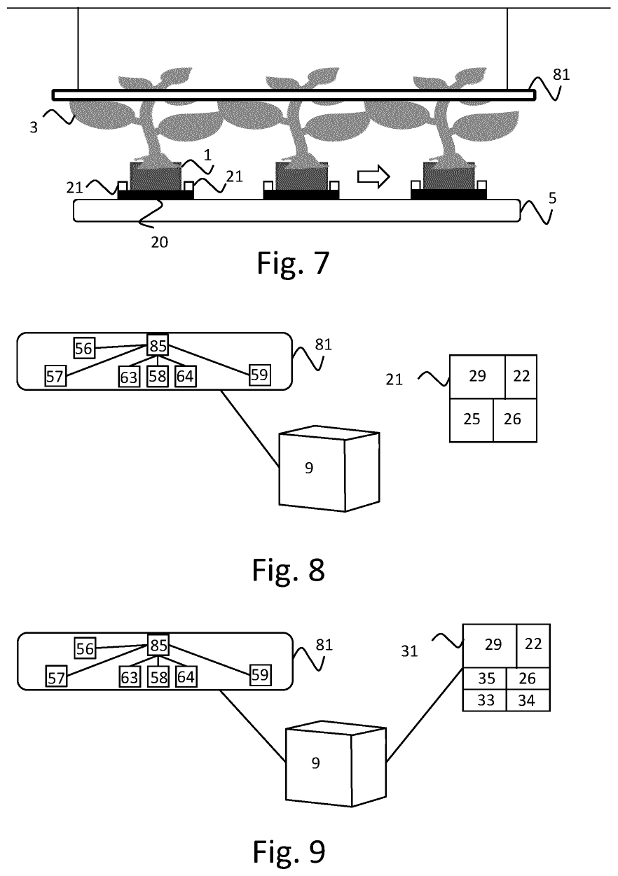

FIG. 7 shows a fifth embodiment of the horticulture lighting system in the plant growing environment. In the embodiment of FIG. 7, the horticulture lighting system comprises a horticulture inter-lighting device 81 and the horticulture bottom-lighting devices 21 of FIG. 2. The horticulture inter-lighting device 81 illuminates the plant 3 from a first position. The horticulture bottom-lighting devices 21 illuminate the plant 3 from second positions.

The horticulture inter-lighting device 81 is described in more detail in relation to FIG. 8. The horticulture inter-lighting device 81 comprises the same power supply 56 and light sources 57-59 as the horticulture inter-lighting devices 51 and 61 of FIGS. 5 and 6, respectively. The horticulture inter-lighting device 81 further comprises the same receiver 63 and transmitter 64 as the horticulture inter-lighting device 61 of FIG. 6. The horticulture inter-lighting device 81 further comprises a processor 85. The processor 85 is configured to determine one or more horticulture master light settings and control the light sources 57-59 to render horticulture master light based on the one or more horticulture master light settings. The horticulture master light further comprises a modulated light communication signal.

In the embodiment of FIG. 8, the processor 85 is configured to determine the one or more horticulture master light settings by transmitting, via transmitter 64, a request message to a server system 9 and receiving, via receiver 63, a response message in return. The response message comprises at least the one or more horticulture master light settings and may comprise the entire light protocol. The horticulture inter-lighting device 81 is referred to in this embodiment as a horticulture master lighting device.

FIG. 9 shows a sixth embodiment of the horticulture lighting system in the plant growing environment. In this sixth embodiment, the horticulture light system comprises the horticulture inter-lighting device 81 of FIG. 8 and the horticulture bottom-lighting device 31 of FIG. 3. The modulated light communication signal comprises a horticulture light protocol identifier and/or an identifier of the horticulture master lighting device.

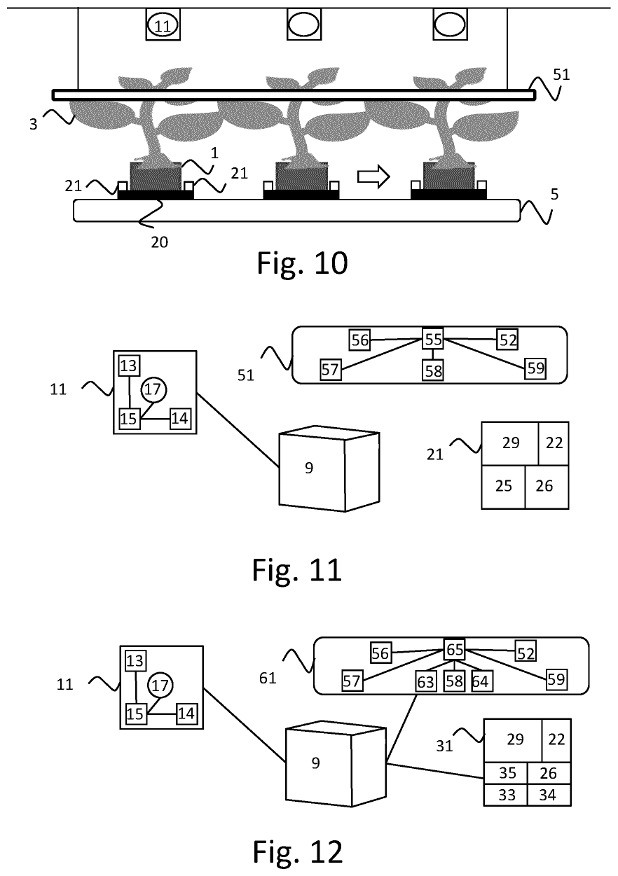

FIGS. 10 and 11 show a seventh embodiment of the horticulture lighting system in the plant growing environment. In the embodiment of FIGS. 10 and 11, the horticulture lighting system comprises the horticulture top-lighting device 11 and the horticulture bottom-lighting devices 21 of FIG. 2 and the horticulture inter-lighting device 51 of FIG. 5. The horticulture top-lighting device 11 illuminates the plant 3 from a first position. The horticulture inter-lighting device 51 illuminate the plant 3 from a second position. The horticulture bottom-lighting devices 21 illuminate the plant 3 from third positions.

FIG. 12 shows an eight embodiment of the horticulture lighting system in the plant growing environment. In the embodiment of FIG. 12, the horticulture lighting system comprises the horticulture top-lighting device 11 of FIG. 2, the horticulture bottom-lighting devices 31 of FIG. 2 and the horticulture inter-lighting device 61 of FIG. 6. The horticulture top-lighting device 11 illuminates the plant 3 from a first position. The horticulture inter-lighting device 61 illuminate the plant 3 from a second position. The horticulture bottom-lighting devices 31 illuminate the plant 3 from third positions.

In the embodiments shown in FIGS. 1 to 12, the lighting devices comprises one processor. In an alternative embodiment, one or more of the lighting devices comprises multiple processors. The processors may be, for example, application-specific processors, e.g. LED controller ICs. The processor may be programmable. The receivers and transmitters may be simple, e.g. receive and transmit analog signals, or complex, e.g. Wi-fi, Zigbee or Bluetooth transceivers. The light sources may each comprise one or more LEDs, for example.

In the embodiments shown in FIGS. 1 to 12, a separate receiver and a separate transmitter are used. In an alternative embodiment, the receiver and the transmitter are combined into a transceiver. The lighting devices may comprise other components typical for a lighting device. The invention may be implemented using a computer program running on one or more processors.

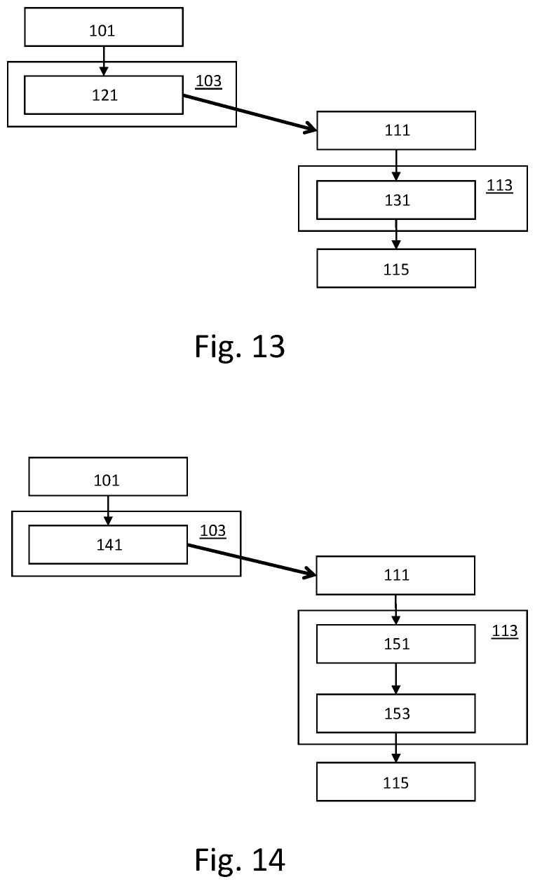

A first embodiment of the methods of illuminating a plant in a plant growing environment with horticulture master light and horticulture slave light is shown in FIG. 13. A step 101 comprises a horticulture master lighting device determining one or more horticulture master light settings. A step 103 comprises the horticulture master lighting device rendering horticulture master light based on the one or more horticulture master light settings. The horticulture master light illuminates the plant from a first position and comprises a visible light communication (VLC) signal.

In the embodiment of FIG. 13, step 103 is implemented in a step 121. Step 121 comprises rendering the horticulture master light including a VLC signal that comprises one or more horticulture slave light settings. This allows the horticulture slave lighting device to work standalone, i.e. without requiring a network connection. The VLC signal may comprise the entire light protocol, for example. The horticulture master lighting device may determine these one or more horticulture slave light settings also in step 101.

A step 111 comprises a horticulture slave lighting device receiving, via a light sensor, the horticulture master light from the horticulture master lighting device. A step 113 comprises the horticulture slave lighting device determining one or more horticulture slave light settings based on the VLC signal. In the embodiment of FIG. 13, step 113 is implemented in a step 131. Step 131 comprises extracting the one or more horticulture slave light settings comprised in the VLC signal from the VLC signal. A step 115 comprises the horticulture slave lighting device rendering horticulture slave light based on the one or more horticulture slave light settings. The horticulture slave light illuminates the plant from a second position. In the embodiment of FIG. 13, the horticulture slave lighting device renders exactly the same light settings that it has received.

A second embodiment of the methods of illuminating a plant in a plant growing environment with horticulture master light and horticulture slave light is shown in FIG. 14. Step 101 comprises a horticulture master lighting device determining one or more horticulture master light settings. Step 103 comprises the horticulture master lighting device rendering horticulture master light based on the one or more horticulture master light settings.

The horticulture master light illuminates the plant from a first position and comprises a visible light communication (VLC) signal. In the embodiment of FIG. 14, step 103 is implemented in a step 141. Step 141 comprises rendering the horticulture master light including a VLC signal that comprises the one or more horticulture master light settings.

Step 111 comprises the horticulture slave lighting device receiving, via a light sensor, the horticulture master light from the horticulture master lighting device. Step 113 comprises the horticulture slave lighting device determining one or more horticulture slave light settings based on the VLC signal. In the embodiment of FIG. 14, step 113 is implemented in steps 151 and 153.

Step 151 comprises extracting the horticulture master light settings comprised in the VLC signal from the VLC signal. Step 153 comprises determining one or more horticulture slave light settings based on the one or more extracted horticulture master light settings by adjusting the one or more extracted horticulture master light settings. In other words, the horticulture slave lighting device determines one or more dependent (interplant) light settings, e.g. a dependent (interplant) light protocol, in step 151.

A step 115 comprises the horticulture slave lighting device rendering horticulture slave light based on the one or more horticulture slave light settings. The horticulture slave light illuminates the plant from a second position. Since the one or more master light settings were adjusted in step 153, the horticulture slave light is different than the horticulture master light. For example, the slave light could be aimed at promoting growth or quality aspects of certain plant organs in particular, such as fruits.

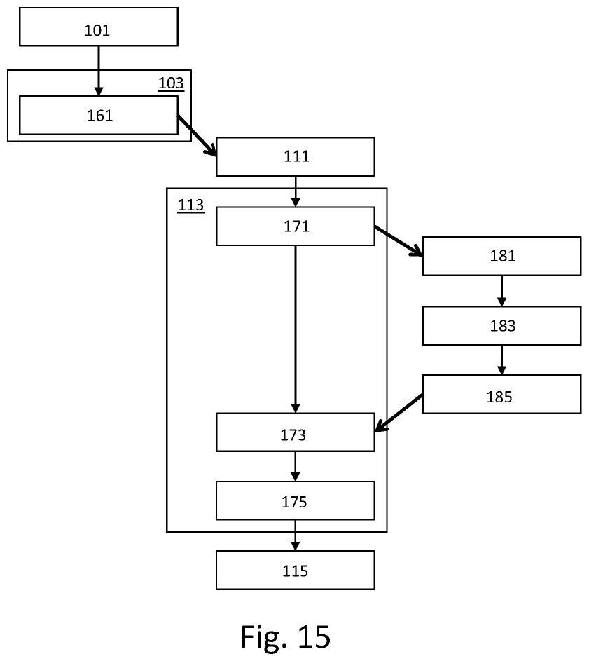

A third embodiment of the methods of illuminating a plant in a plant growing environment with horticulture master light and horticulture slave light is shown in FIG. 15. Step 101 comprises a horticulture master lighting device determining one or more horticulture master light settings. Step 103 comprises the horticulture master lighting device rendering horticulture master light based on the one or more horticulture master light settings.

The horticulture master light illuminates the plant from a first position and comprises a visible light communication (VLC) signal. In the embodiment of FIG. 14, step 103 is implemented in a step 161. Step 161 comprises rendering the horticulture master light with a VLC signal that comprises a light protocol identifier and/or an identifier of the horticulture master lighting device.

Step 111 comprises the horticulture slave lighting device receiving, via a light sensor, the horticulture master light from the horticulture master lighting device. Step 113 comprises the horticulture slave lighting device determining one or more horticulture slave light settings based on the VLC signal in the received horticulture master light. In the embodiment of FIG. 14, step 113 is implemented in steps 171-175.

Step 171 comprises the horticulture slave lighting device transmitting a request message comprising the light protocol identifier and/or the identifier of the horticulture master lighting device to a server system. Step 173 comprises the horticulture slave lighting device receiving the one or more horticulture slave light settings from the server system in response to the transmission of the request message. Step 175 comprises the horticulture slave lighting device extracting the one or more horticulture slave light settings from the server system's response message. The one or more horticulture slave light settings are typically different than the one or more horticulture master light settings. In other words, the horticulture slave lighting device typically determines/extracts one or more dependent (interplant) light settings, e.g. a dependent (interplant) light protocol, in step 175.

In an alternative embodiment, step 173 comprises receiving one or more horticulture master light settings from the server system in response to the transmission of the request message and step 175 comprises extracting the one or more horticulture master light settings from the server system's response message. In this alternative embodiment, step 153 of FIG. 14 may be performed after step 175.

A step 181 comprises the server system receiving the request message from the horticulture slave lighting device. A step 183 comprises the server system determining one or more horticulture light settings from a light protocol associated with the light protocol identifier and/or the identifier of the horticulture master lighting device included in the request message. The light protocol may be stored in a database of light protocols. A step 185 comprises transmitting a response message comprising at least the one or more horticulture light settings determined in step 183 to the horticulture slave lighting device. The response message may comprise details from the associated light protocol like spectrum, brightness, schedule, and growth stage, for example.

If the request message does not comprise a light protocol identifier, the server system may be able to identify the light protocol active at the horticulture master lighting device based on the device identifier. The identifier of the horticulture master lighting device may identify a location of the horticulture master lighting device, for example.

The light protocol may specify one or more horticulture light settings per type of device, e.g. one or more horticulture light settings for a top-lighting device, one or more horticulture light settings for an inter-lighting device, and one or more horticulture light settings for a bottom-lighting device. The request message may comprise information indicating the type of the horticulture slave lighting device or the type of the horticulture slave lighting device may be pre-defined, for example. The server system may obtain the one or more horticulture light settings associated with this type of device from the light protocol in step 183.

Alternatively, the light protocol may specify only one set of one or more horticulture light settings. In this case, the server system may obtain this set of one or more horticulture light settings and determine the one or more horticulture slave light settings by adjusting the obtained set of one or more horticulture light settings in step 183. In this case, step 183 may comprise step 153 of FIG. 14 or a similar step as sub step, for example.

The request message may comprise information describing hardware characteristics of the horticulture slave lighting device. In this case, step 183 comprises obtaining one or more horticulture light settings from the light protocol based on the hardware characteristics of the horticulture slave lighting device or adjusting or more horticulture light settings obtained from the light protocol based on the hardware characteristics of the horticulture slave lighting device.

Information describing the type of the horticulture slave lighting device may also be usable as information describing hardware characteristics of the horticulture slave lighting device, e.g. if the type indicates more than just the height of the horticulture slave lighting device or if the height of the horticulture slave lighting device is associated with certain hardware characteristics in this plant growing environment. In an alternative embodiment, the request message comprises an identifier of the horticulture slave lighting device and the server system obtains hardware characteristics of the horticulture slave lighting device based on this identifier.

Thus, based on the request message, the server system sends back one or more horticulture light settings which are customized for the detected light protocol and hardware characteristics of the horticulture slave lighting device. In other words, the one or more horticulture slave light settings received by the horticulture slave lighting device in step 173 are determined based on the hardware characteristics of the horticulture slave lighting device.

Step 115 is performed after the one or more horticulture master light settings have been extracted from the server system's response message in step 175. Step 115 comprises the horticulture slave lighting device rendering horticulture slave light based on the one or more horticulture slave light settings. The horticulture slave light illuminates the plant from a second position.

In the embodiments of FIGS. 13 to 15, the horticulture master light comprises a visible light communication signal. In a variation on these embodiments, the master light comprises a different type of modulated light communication signal, e.g. an infrared light communication signal.

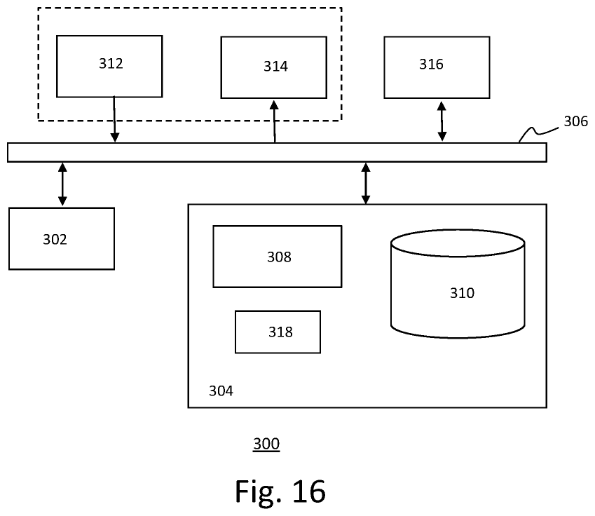

FIG. 16 depicts a block diagram illustrating an exemplary data processing system that may perform the method as described with reference to FIGS. 13 to 15.

As shown in FIG. 16, the data processing system 300 may include at least one processor 302 coupled to memory elements 304 through a system bus 306. As such, the data processing system may store program code within memory elements 304. Further, the processor 302 may execute the program code accessed from the memory elements 304 via a system bus 306. In one aspect, the data processing system may be implemented as a computer that is suitable for storing and/or executing program code. It should be appreciated, however, that the data processing system 300 may be implemented in the form of any system including a processor and a memory that is capable of performing the functions described within this specification.

The memory elements 304 may include one or more physical memory devices such as, for example, local memory 308 and one or more bulk storage devices 310. The local memory may refer to random access memory or other non-persistent memory device(s) generally used during actual execution of the program code. A bulk storage device may be implemented as a hard drive or other persistent data storage device. The processing system 300 may also include one or more cache memories (not shown) that provide temporary storage of at least some program code in order to reduce the quantity of times program code must be retrieved from the bulk storage device 310 during execution. The processing system 300 may also be able to use memory elements of another processing system, e.g. if the processing system 300 is part of a cloud-computing platform.

Input/output (I/O) devices depicted as an input device 312 and an output device 314 optionally can be coupled to the data processing system. Examples of input devices may include, but are not limited to, a keyboard, a pointing device such as a mouse, a microphone (e.g. for voice and/or speech recognition), or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 16 with a dashed line surrounding the input device 312 and the output device 314). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 316 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 300, and a data transmitter for transmitting data from the data processing system 300 to said systems, devices and/or networks. Modems, cable modems, and Ethernet cards are examples of different types of network adapter that may be used with the data processing system 300.

As pictured in FIG. 16, the memory elements 304 may store an application 318. In various embodiments, the application 318 may be stored in the local memory 308, the one or more bulk storage devices 310, or separate from the local memory and the bulk storage devices. It should be appreciated that the data processing system 300 may further execute an operating system (not shown in FIG. 16) that can facilitate execution of the application 318. The application 318, being implemented in the form of executable program code, can be executed by the data processing system 300, e.g., by the processor 302. Responsive to executing the application, the data processing system 300 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 302 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. A horticulture slave lighting device for illuminating a plant in a plant growing environment, said horticulture slave lighting device comprising:
a light sensor configured for receiving horticulture master light from a horticulture master lighting device, said horticulture master light comprising a modulated light communication signal and said horticulture master light illuminating said plant from a first position;
a light source; and
at least one processor configured to:
receive, via said light sensor, said modulated light communication signal,
determine one or more horticulture slave light settings based on said modulated light communication signal, and
control said light source to render horticulture slave light based on said one or more horticulture slave light settings, said horticulture slave light illuminating said plant from a second position;
wherein said horticulture slave light is different from said horticulture master light thereby illuminating said plant from said second position with a different horticulture light that illuminating said plant from said first position.

2. The horticulture slave lighting device s as claimed in claim 1, wherein said horticulture slave lighting device is adapted to move together with said plant in said plant growing environment.

3. The horticulture slave lighting device as claimed in claim 1, wherein said horticulture slave lighting device is embedded in a plant tray, plant gully, or plant pot or attached to a plant, plant tray, plant gully, or plant pot.

4. The horticulture slave lighting device as claimed in claim 1, wherein said horticulture slave lighting device is one of: a top-lighting device, an inter-lighting device and a bottom-lighting device.

5. The horticulture slave lighting device as claimed in claim 1, wherein said received modulated light communication signal comprises at least one of: said one or more horticulture slave light settings, one or more horticulture master light settings, a horticulture light protocol identifier, and an identifier of said horticulture master lighting device.

6. The horticulture slave lighting device as claimed in claim 5, wherein said received modulated light communication signal comprises said one or more horticulture master light settings and said at least one processor is configured to determine said one or more horticulture slave light settings based on said one or more horticulture master light settings by adjusting said one or more horticulture master light settings.

7. The horticulture slave lighting device as claimed in claim 5, further comprising a transmitter and a receiver wherein said received modulated light communication signal comprises said light protocol identifier and/or said identifier of said horticulture master lighting device and said at least one processor is configured to:
transmit, via said transmitter, said light protocol identifier and/or said identifier of said horticulture master lighting device to a server system, and
receive, via said receiver, said one or more horticulture slave light settings and/or one or more horticulture master light settings from said server system in response to said transmission.

8. The horticulture slave lighting device as claimed in claim 7, wherein said at least one processor is configured to:
transmit information describing hardware characteristics of said horticulture slave lighting device to said server system along with said light protocol identifier and/or said identifier of said horticulture master lighting device, and
receive said one or more horticulture slave light settings from said server system in response to said transmission, said one or more horticulture slave light settings being determined based on said hardware characteristics of said horticulture slave lighting device.

9. The horticulture slave lighting device as claimed in claim 7, wherein said identifier of said horticulture master lighting device identifies a location of said horticulture master lighting device.

10. The horticulture slave lighting device as claimed in claim 1, wherein said one or more horticulture master light settings and/or said one or more horticulture slave light settings comprise a spectral light distribution setting and/or a light intensity level.

11. A horticulture master lighting device for illuminating a plant in a plant growing environment, said horticulture master lighting device comprising:
a light source; and
at least one processor configured to:
determine one or more horticulture master light settings, and
control said light source to render horticulture master light based on said one or more horticulture master light settings, said horticulture master light further comprising a modulated light communication signal, said modulated light communication signal comprising a horticulture light protocol identifier.

12. The horticulture lighting system for illuminating a plant in a plant growing environment, said system comprising a horticulture slave lighting device according to claim 1 wherein said horticulture slave lighting device is adapted to move with said plant in said plant growing environment.

13. A method of illuminating a plant in a plant growing environment with horticulture slave light, said method comprising:
receiving, via a light sensor, horticulture master light from a horticulture master lighting device, said horticulture master light comprising a modulated light communication signal and said horticulture master light illuminating said plant from a first position;
determining one or more horticulture slave light settings based on said modulated light communication signal; and
rendering said horticulture slave light based on said one or more horticulture slave light settings, said horticulture slave light illuminating said plant from a second position;
wherein said horticulture slave light is different from said horticulture master light thereby illuminating said plant from said second position with a different horticulture light that illuminating said plant from said first position.

14. A non-transitory computer readable medium comprising instructions, the instructions when executed by a processor of a horticulture slave lighting device causes the processor to perform the method of claim 13.

15. A method of illuminating a plant in a plant growing environment with horticulture master light, said method comprising:
determining one or more horticulture master light settings; and
rendering said horticulture master light based on said one or more horticulture master light settings, said horticulture master light further comprising a modulated light communication signal, said modulated light communication signal comprising a horticulture light protocol identifier.
